(19) United States
(12) Patent Application Publication
(10) Pub. No.: US 2002/0152269 A1
(43) Pub. Date: Oct. 17, 2002

(54) Information providing system and privacy protection method

(76) Inventor: Shigehiro Ichimura, Tokyo (JP)

Correspondence Address: McGinn & Gibb, PLLC, Suite 200, 8321 Old Courthouse Road, Vienna, VA, 22182-3817, US

(21) Appl. No.: 10/118,945

(22) Filed: Apr. 10, 2002

(30) Foreign Application Priority Data
Apr. 11, 2001 (JP) 2001-112083

(51) Int. Cl. G06F 15/16

(52) U.S. Cl. 709/203; 709/219

(57) ABSTRACT

An information providing system modifies the position of a user terminal that accesses a server at the user terminal itself or an intervening device and the modified position is sent to the server. Accordingly, a possibility that the user terminal is identified from position information is substantially lowered, resulting in further enhanced privacy protection.

### BACKGROUND OF THE INVENTION

1. Field of the Invention

The present invention relates to an information providing system and in particular to an information providing system using position information of a user to provide position-related information to the user and a privacy protection method therefor.

2. Description of the Related Art

With the widespread use of mobile communication terminals, attention is being given to an information providing system, which allows a user to obtain position-related information such as traffic information in response to a user's request. For example, when a user having a navigation device in a car desires traffic information around the position of the user, the user operates the navigation device to send a traffic information request to an information providing server. When receiving such a request, the server searches a traffic information database and sends desired traffic information back to the user's navigation device.

In general, the traffic information request includes a user ID uniquely assigned to the user. Accordingly, when the user ID is received, it can be easily identified who requests the information.

To protect the user's privacy, Japanese Patent Application Unexamined Publication No. 11-340895 discloses a traffic information collecting system allowing anonymous traffic information to be collected from navigation devices.

A navigation device is provided with a mode designation means, by which traffic information can be sent in an anonymous mode, that is, without attaching its user ID. In the traffic information collecting system, when having received the traffic information having no user ID, it is attached with a unique ID and is then registered on the traffic information database.

However, even though the user ID is not sent, there is a possibility that the user's privacy is not assured. More specifically, the request or message from the user includes the position information of the user. Accordingly, if this position information is revealed, it is possible to identify the user that has sent the request by searching users located at the position.

### SUMMARY OF THE INVENTION

An object of the present invention is to provide an information providing system and privacy protection method allowing enhanced privacy protection.

According to the present invention, the position of a user terminal is modified before sent to a server.

According to the present invention, an information providing system for providing position-related information from an information providing server to a user terminal through a network to which a plurality of user terminals are connected, wherein the position-related information relates to a position of the user terminal, includes: a position modifier for modifying a position of the user terminal to produce a modified position, wherein the modified position is transmitted as a position of the user terminal to the information providing server.

According to an aspect of the present invention, the user terminal includes the position modifier. The user terminal further includes: a position detector for detecting the position of the user terminal; and a transmitter for transmitting a request having the modified position as a source position to the information providing server, wherein the information providing server transmits the position-related information to the user terminal in response to the request from the user terminal.

According to another aspect of the present invention, the system further includes an intervening device connected to the network, for intervening in communication from the user terminal to the information providing server, wherein the intervening device comprises the position modifier. More specifically, the user terminal includes: the position detector; and a first transmitter for transmitting a first request having the position to the intervening device through the network. The intervening device includes: a receiver for receiving the first request from the user terminal; the position modifier for modifying the position of the user terminal included in the first request to produce the modified position; and a second transmitter for transmitting a second request having the modified position as a source position to the information providing server, wherein the information providing server transmits the position-related information to the user terminal in response to the second request received from the intervening device.

The modified position may be set to an arbitrary position within a predetermined radius of the position of the user terminal. The modified position may be set to an arbitrary position at a predetermined distance away from the position of the user terminal.

In the case where position of the user terminal is represented by at least two values, the modified position may be represented by reducing the number of significant figures of each of said at least two values. Preferably, the modified position is set to an arbitrary position within a radius of the position of the user terminal, wherein the radius is set to a distance from the position of the user terminal to that of a selected other user terminal.

The intervening device may further include: a table for storing position information of the plurality of user terminals, wherein the position modifier modifies the position of the user terminal by searching the table to select one of positions of the plurality of user terminals.

As described above, according to the present invention, the position of a user terminal that accesses a server is modified by the user terminal itself or an intervening device in the network. The modified position is notified to the server. Accordingly, a possibility that the user terminal is identified from position information is substantially lowered, resulting in further enhanced privacy protection.

### BRIEF DESCRIPTION OF THE DRAWINGS

FIG. 1 is a block diagram showing an information providing system according to a first embodiment of the present invention;

FIG. 2 is a flow chart showing an operation of the information providing system as shown in FIG. 1;

FIG. 3 is a diagram showing a format of a position-related information request used in the information providing system as shown in FIG. 1;

FIG. 4 is a block diagram showing an information providing system according to a second embodiment of the present invention;

FIG. 5 is a flow chart showing an operation of the information providing system as shown in FIG. 4;

FIG. 6A is a diagram showing a format of a position-related information request used in the information providing system as shown in FIG. 4;

FIG. 6B is a diagram showing a format of a modified-position-related information request used in the information providing system as shown in FIG. 4;

FIG. 7 is a block diagram showing a privacy protection intervening device in an information providing system according to a third embodiment of the present invention;

FIG. 8 is a diagram showing an example of a position management table in the privacy protection intervening device as shown in FIG. 7;

FIG. 9 is a flow chart showing an operation of the privacy protection intervening device as shown in FIG. 7;

FIG. 10 is a schematic diagram showing an example of user position distribution; and

FIG. 11 is a diagram showing an example of the position management table in the case of the user position distribution as shown in FIG. 10.

### DESCRIPTION OF THE PREFERRED EMBODIMENTS

First Embodiment

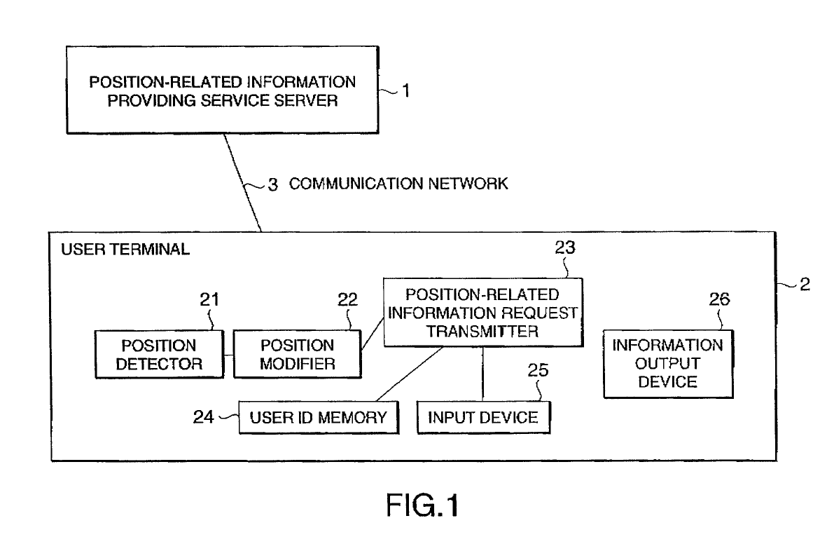

Referring to FIG. 1, an information providing system according to a first embodiment of the present invention is composed of a position-related information providing service server 1, a plurality of user terminals (here, one user terminal 2 is shown), and a communication network 3. The position-related information providing service server 1 and the user terminal 2 are connected to each other through the communication network 3.

The user terminal 2 is a mobile terminal such as a mobile telephone, a PHS (Personal Handy phone System) terminal, or another kind of wireless communication terminal. The communication network 3 allows communications between the position-related information providing service server 1 and the user terminal 2, such as public telephone switched network, PHS network, mobile telephone network, wireless LAN (Local Area Network), infrared communication network, optical communication network, or a combination thereof.

The position-related information providing service server 1 has a receiving function of receiving a position-related information request from the user terminal 2 through the communication network 3, a searching function for searching for position-related information such as traffic information based on the received position information, and a transmitting function of transmitting the found position-related information to the user terminal 2 that is a source of the request.

The user terminal 2 includes a position detector 21, a position modifier 22, a position-related information request transmitter 23, a user ID memory 24, an input device ²⁵, and an information output device 26.

The position detector 21 detects the position of the user terminal 2, that is, its user. The position can be detected by GPS (Global Positioning System). Alternatively, a mobile communication system may be used to detect the position. For example, base station information received from a nearest base station can be used to determine the position of the user terminal 2 (see Japanese Patent Application Unexamined Publication No. 5-72314). In the case of using the GPS system, the position detector 21 receives (PS signals to produce position information, which maybe represented by East Longitude and North Latitude, for example, 135 degrees, 20 minutes, 40 seconds east longitude (Long. 135°20′40″E) and 35 degrees, 30 minutes, 21 seconds north latitude (Lat. 35°30′21″N).

The position modifier 22 inputs the position information detected by the position detector 21 and modifies it to output modified position information to the position-related information request transmitter 23. The position modification will be described later.

The position-related information request transmitter 23 inputs the modified position information from the position modifier 22, user identification (ID) from the user ID memory 24, and a request condition from the input device 25, and uses these information to produce a position-related information request. The position-related information request is transmitted to the position-related information providing service server 1 via the communication network 3.

The input device 25 is used by the user to enter a request condition, data and various instructions. Specifically, the input device 25 may be a keypad or a touch-sensitive panel. The information output device 26 is used to provide the user with necessary information including the position-related information such as traffic information, which was received from the server 1 via the network 3. The information output device 26 may be a display such as CRT or LCD, a printer, and/or a speaker.

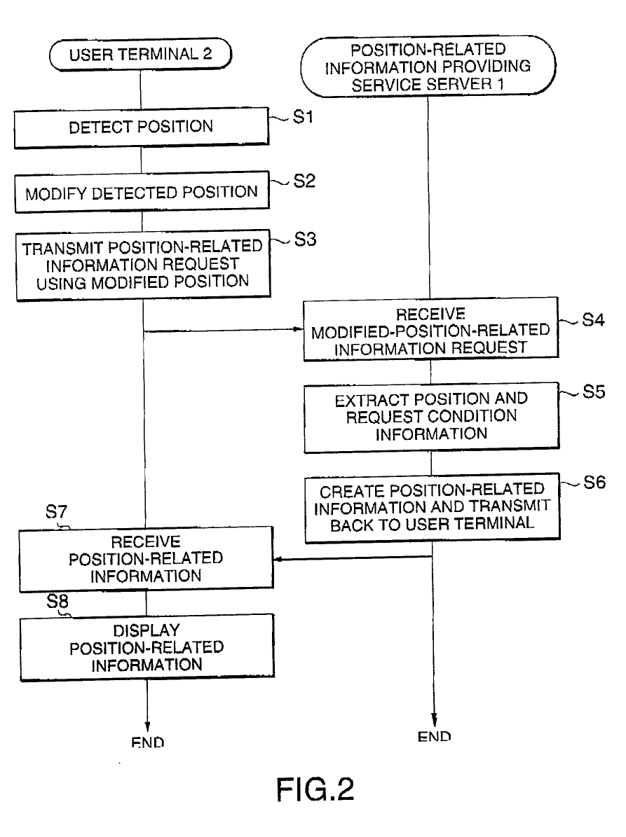

Next, an operation of the information providing system as shown in FIG. 1 will be described with reference to FIG. 2.

When a user #1 wants to obtain information related to the present position of the user #1 from the position-related information providing service server 1, the user #1 uses the input device 25 to enter a request condition indicating what kind of information is desired. The input request condition is output to the position-related information request transmitter 23.

Referring to FIG. 2, the position detector 21 detects the position of the user terminal 2 of the user #1 (step S1) and outputs position information (e.g. Long. 135°20′40″E and Lat. 35°30′21″N) to the position modifier 22.

The position modifier 22 modifies the position information (step S2). For example, the position is modified to an arbitrary position at a predetermined distance away from the detected position of the user terminal 2 or within a predetermined radius of the detected position. In the case of the position information being Long. 135°20′40″E and Lat. 35°30′21″N, for example, it may be changed to a position at a one-second distance from that detected position. Accordingly, the modified position is represented by Long. 135°20′41″E and Lat. 35°30′22″N.

Alternatively, it is possible to modify the detected position by reducing the number of significant figures. In the case of the position information being Long. 135°20′40″E and Lat. 35°30′21″N, for example, it may be changed to a position represented by Long. 135°20′E and Lat. 35°30′N.

In this manner, an amount of position modification is restricted within a predetermined distance to avoid increasing markedly in distance between the modified and actual positions. Such a different position from the actual position of the user #1 is sent to the server 1. Accordingly, the user's privacy can be effectively protected while maintaining useful position-related information for the user #1.

The position-related information request transmitter 23 uses the modified position information, the user identification (ID), and the request condition to produce a position-related information request and transmit it to the position-related information providing service server 1 via the communication network 3 (step S3).

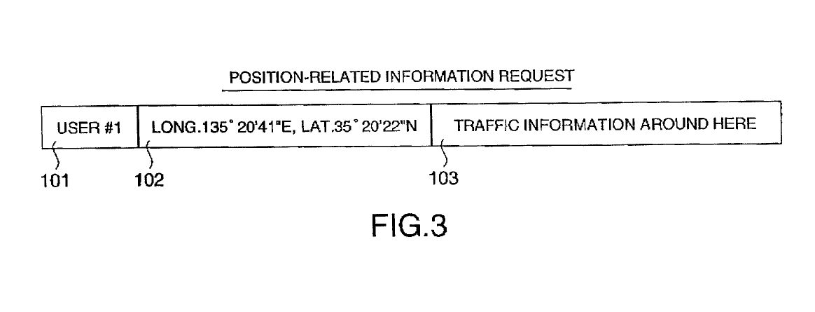

The position-related information request has a format, as shown in FIG. 3, including a user identification section 101, a position information section 102, and a request condition section 103. In this example, the user identification section 101 stores the user ID of the user #1, the position information section 102 stores the modified position information of Long. 135°20′41″E and Lat. 35°30′22″N, and the request condition section 103 stores a condition indicative of requesting traffic information around here.

When having received the position-related information request from the user terminal 2 through the communication network 3 (step S4), the position-related information providing service server 1 extracts the position information (here, “Long. 135°20′41″E and Lat. 35°30′22″N”) and the request condition (here, “traffic information around here”) from the received request (step S5). The position-related information providing service server 1 uses the position information and the request condition to create position-related information and send it back to the user terminal 2 (step S6).

When having received the position-related information from the server 1 (step S7), the user terminal 2 displays the received information through the information output device 26 to present it to the user #1 (step S8).

The above operation of the user terminal 2 as shown in FIG. 2 may be realized by software running on a program-controlled processor. More specifically, the user terminal 2 is provided with a central processing unit (CPU), on which a control program runs to implement the position modifier 22, the position-related information request transmitter 23, the user ID memory 24, the input device 25, and the information output device 26.

Second Embodiment

According to a second embodiment of the present invention, position modification that is performed within the user terminal 2 in the first embodiment is performed in a privacy protection intervening device 4 which is connected to the communication network 3. Accordingly, there is no need of providing the user terminal 2 with a position modifying function implemented by the position modifier 22, resulting in simplified circuit and reduced cost of the user terminal 2. In other words, there is no need of modifying the circuit of the user terminal 2. Hereinafter, circuit blocks similar to those previously described with reference to FIG. 1 are denoted by the same reference numerals and the details will be omitted.

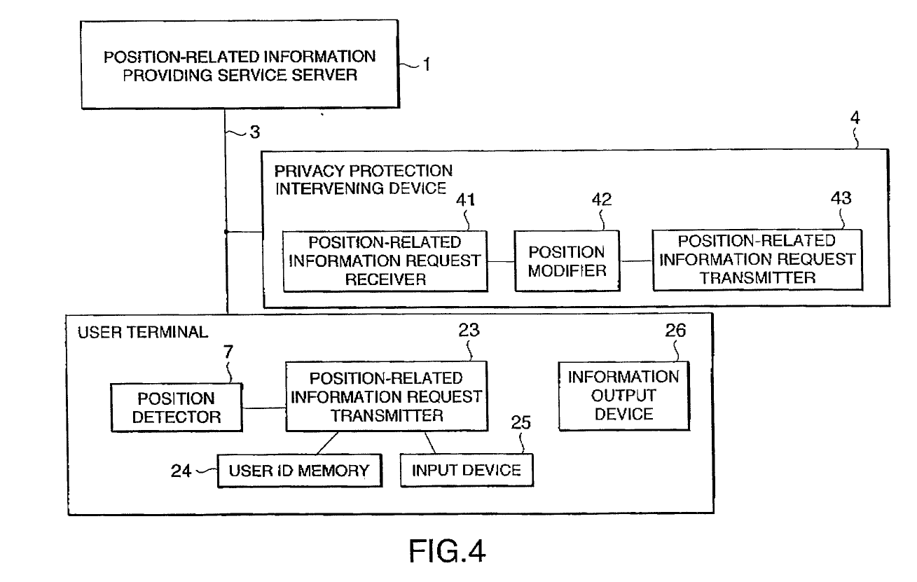

Referring to FIG. 4, an information providing system according to the second embodiment of the present invention is composed of the position-related information providing service server 1, a plurality of user terminals (here, one user terminal 2 is shown), the communication network 3 and the privacy protection intervening device 4 which is connected to the communication network 3.

As described above, the user terminal 2 does not have the position modifier 22. Accordingly, the position-related information request transmitter 23 inputs the detected position information from the position detector 21, user identification (ID) from the user ID memory 24, and a request condition from the input device 25, and uses these information to produce a position-related information request, which is transmitted to the privacy protection intervening device 4 via the communication network 3.

The privacy protection intervening device 4 is provided with a position-related information request receiver 41, a position modifier 42, arid a position-related information request transmitter 43. The position-related information request receiver 41 receives the position-related information request from the user terminal 2. The position modifier 42 modifies the position information included in the received position-related information request and outputs a modified-position-related information request including the modified position information to the position-related information request transmitter 43. The position-related information request transmitter 43 transmits the modified-position-related information request to the position-related information providing service server 1 via the communication network 3.

The position-related information providing service server 1 receives a position-related information request from the privacy protection intervening device 4 through the communication network 3 and sends position-related information such as traffic information back to the user terminal 2 that is a source of the request.

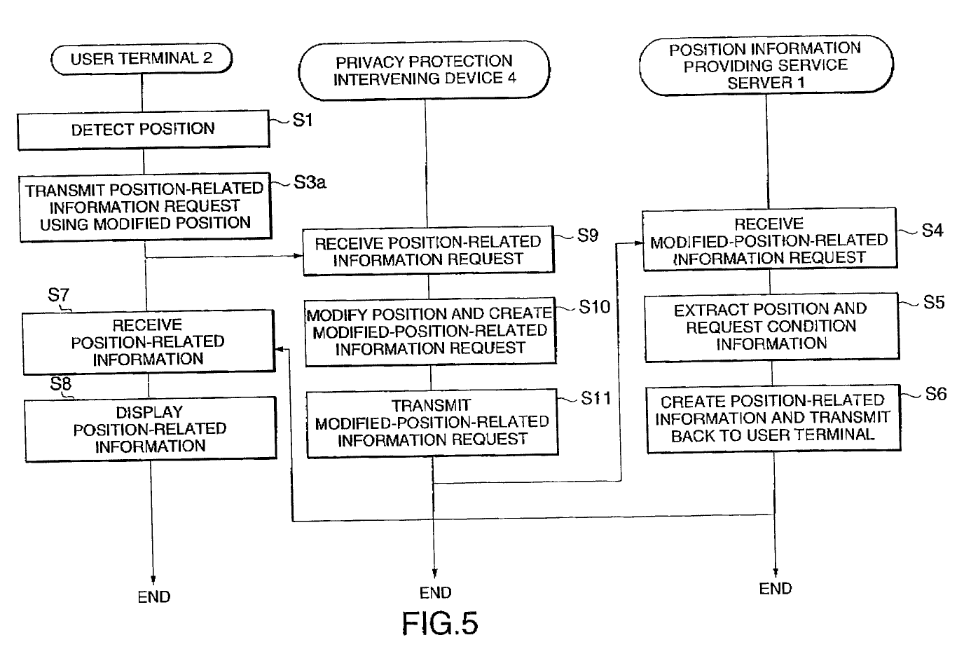

Next, an operation of the information providing system as shown in FIG. 4 will be described with reference to FIG. 5. In FIG. 5, steps similar to those previously described with reference to FIG. 2 are denoted by the same reference numerals and the details will be omitted.

When a user #2 wants to obtain information related to the present position of the user 42 from the position-related information providing service server 1, the user #2 uses the input device 25 to enter a request condition indicating what kind of information is desired. The input request condition is output to the position-related information request transmitter 23.

Referring to FIG. 5, it is assumed that the position detector 21 detects the position of the user terminal 2 of the user #2 (step S1) and outputs position information (e.g. Long. 135°20′40″E and Lat. 35°30′21″N) to the position-related information request transmitter 23.

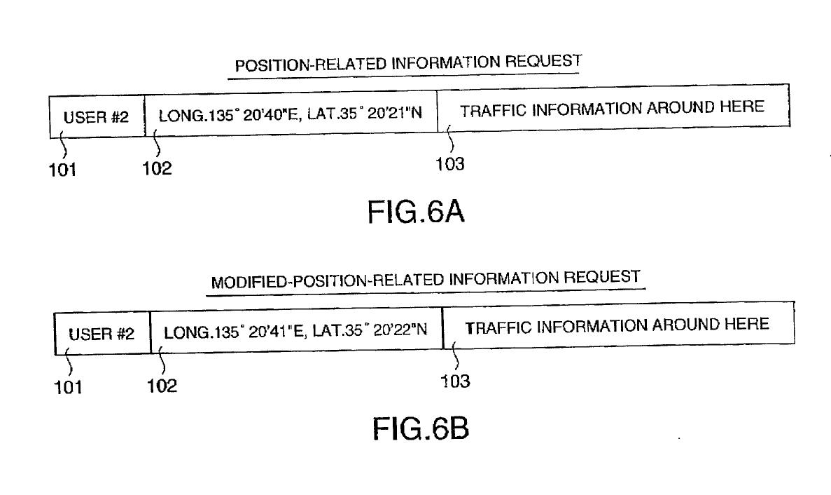

The position-related information request transmitter 23 uses the detected position information, the user identification (ID), and the request condition to produce a position-related information request and transmit it to the privacy protection intervening device 4 via the communication network 3 (step S3a) The position-related information request transmitted from the user terminal 2 has a format, as shown in FIG. 6A, which is the same as that of FIG. 3. In this example, the user identification section 101 stores the user ID of the user #2, the position information section 102 stores the detected position information of Long. 135°20′40″E and Lat. 35°30′21″N, and the request condition section 103 stores a condition indicative of requesting traffic information around hero.

In the privacy protection intervening device 4, the position-related information request receiver 41 receives the position-related information request from the user terminal 2 (step S9). The position modifier 42 modifies the position information included in the received position-related information request to produce a modified-position-related information request including the modified position information (step S10). In the case of the received position information being Long. 135°20′40″E and Lat. 35°30′21″N, for example, it may be changed to a position at a one-second distance from that detected position. Accordingly, the modified position is represented by Long. 135°20′41″E and Lat. 35°30′22″N.

The position-related information request transmitter 43 inputs the modified-position-related information request and transmits it to the position-related information providing service server 1 via the communication network 3 (step S11).

The modified-position-related information request transmitted from the privacy protection intervening device 4 has a format, as shown in FIG. 6B, which is the same as that of FIG. 6A. In this example, the user identification section 101 stores the user ID of the user #2, the position information section 102 stores the modified position information of Long. 135°20′41″E and Lat. 35°30′22″N, and the request condition section 103 stores a condition indicative of requesting traffic information around here.

When having received the modified-position-related information request from the privacy protection intervening device 4 through the communication network 3 (step S4), the position-related information providing service server 1 extracts the position information (here, “Long. 135°20′41″E and Lat. 35°30′22″N”) and the request condition (here, “traffic information around here”) from the received request (step S5). The position-related information providing service server 1 uses the position information and the request condition to create position-related information and send it back to the user terminal 2 (step S6).

When having received the position-related information from the server 1 (step S7), the user terminal 2 displays the received information through the information output device 26 to present it to the user #2 (step S8).

Third Embodiment

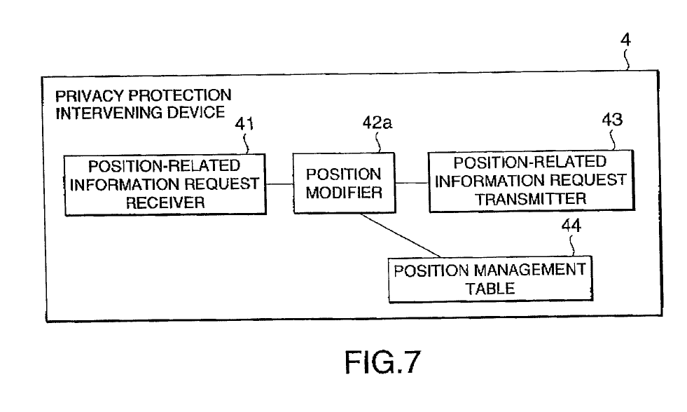

As shown in FIG. 7, in a privacy protection intervening device 4 according to a third embodiment of the present invention, a position management table 44 is added to the privacy protection intervening device 4 according to the second embodiment and an operation of a position modifier 42a is different from that of the second embodiment. Hereinafter, circuit blocks similar to those previously described with reference to FIG. 4 are denoted by the same reference numerals and the details will be omitted.

The position-related information request receiver 41 receives the position-related information request from the user terminal 2. The position modifier 42 extracts the position information and the user ID from the received position-related information request and registers them on the position management table 44.

Further, the position modifier 42 modifies the position information included in the received position-related information request by referring to the position management table 44 as described later. Then the position modifier 42 outputs a modified-position-related information request including the modified position information to the position-related information request transmitter 43. The position-related information request transmitter 43 transmits the modified-position-related information request to the position-related information providing service server 1 via the communication network 3.

1) Registration

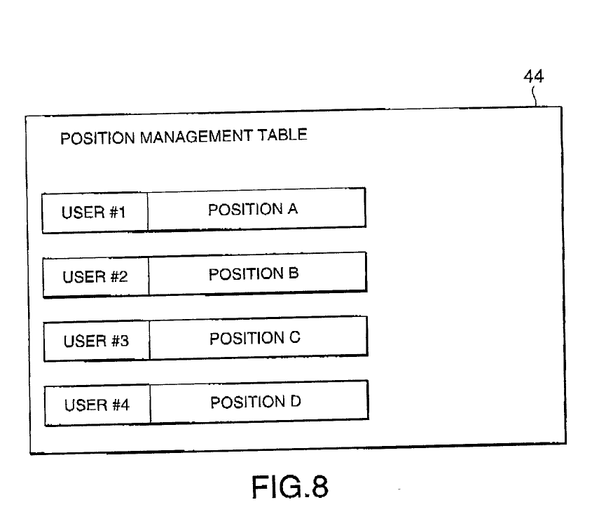

As shown in FIG. 8, the position management table 44 contains a plurality of entries, each of which consists of a pair of user ID and position of the user. In this example, positions A-D corresponding to respective ones of users #1-#4 and are registered in the position management table 44. By referring to this position management table 44, it is found that the user #1 is located at the position A, for example.

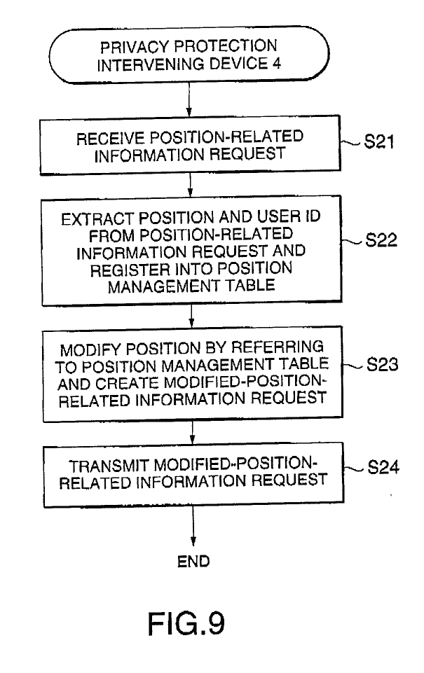

Referring to FIG. 9, the position-related information request receiver 41 receives the position-related information request from the user terminal 2 (step S21). The position modifier 42 extracts the position information and the user ID from the received position-related information request and registers them as an entry on the position management table 44 (step S22). Accordingly, when the users #1-#4 located at respective ones of positions A-D have transmitted position-related information requests, the position management table 44 stores the four entries as shown in FIG. 8.

2) New Position-Related Information Request

It is assumed that the position management table 44 stores four entries of users #1-#4 and positions A-D as shown in FIG. 8 and another user #5 located at a position E newly transmits a position-related information request to the privacy protection intervening device 4.

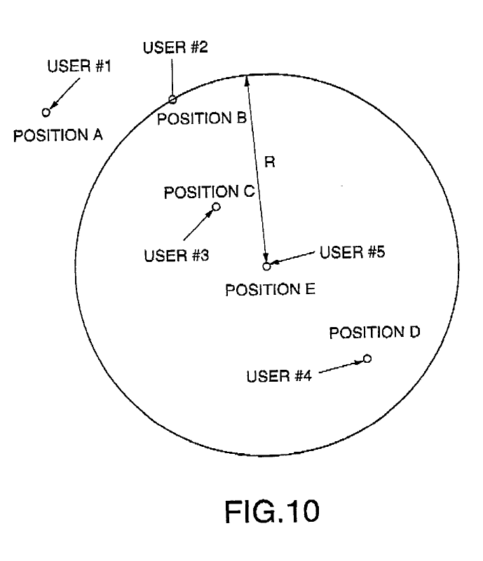

It is further assumed that, when the user #5 transmits the position-related information request, the respective users #1-#4 are located at the positions A-D as shown in FIG. 10.

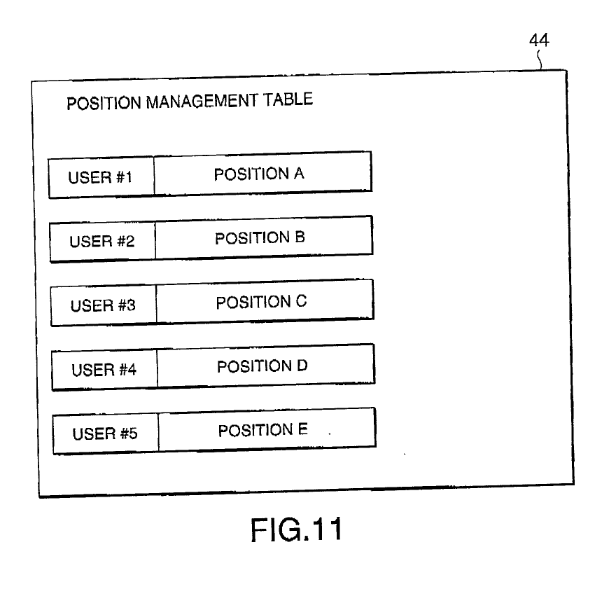

As described above, when the user #5 has transmitted the position-related information request, a new pair of user #5 and position E is registered on the position management table 44 as shown in FIG. 11.

Returning to FIG. 9, when receiving the position-related information request, the position modifier 42 searches the position management table 44 to modify the position information to another position information as described later, and thereafter the position modifier 42 creates a modified-position-related information request including the modified position information and outputs it to the position-related information request transmitter 43 (step S23). The position-related information request transmitter 43 transmits the modified-position-related information request to the position-related information providing service server 1 via the communication network 3 (step S24).

3) Position Modification

Referring to FIG. 10, in the case where the new user #5 is located at the position E, the position E is modified to an arbitrary position within a predetermined radius R of the position E. In this example, the radius R is set to a distance from the position E to the position B of the user #2, which is the third nearest one. The radius R of the position E may be set to a distance to an arbitrary position registered in the position management table 44.

In this manner, the actual position 2 can be modified to a different position that is near the actual position E and a position of another user. Accordingly, even if a position-related information provider intends to identify a user requesting for the position-related information based on the position information included in the request, a plurality of users are found around the modified position, resulting in difficulty in identifying the target user and enhanced protection of privacy.

Further, according to the above position modification, the amount of position modification when the number of users per unit area is high is smaller than that when it is low. For example, in a mall where high numbers of users visit during the daytime and small numbers during the night, position information can be provided to users with high precision during the daytime and with low precision during the night. In other woods, it is possible to select a desired precision of position information service depending on surrounding density of population.

The above operations of the privacy protection intervening device 4 as shown in FIGS. 5 and 9 may be realized by software running on a program-controlled processor. More specifically, the privacy protection intervening device 4 is provided with a CPU, on which a control program runs to implement the position modifier 42 or 42a and the position management table 44.

1. An information providing system for providing position-related information from an information providing server to a user terminal through a network to which a plurality of user terminals are connected, wherein the position-related information relates to a position of the user terminal, comprising:
a position modifier for modifying a position of the user terminal to produce a modified position,
wherein the modified position is transmitted as a position of the user terminal to the information providing server.

2. The information providing system according to claim 1, wherein the user terminal comprises the position modifier.

3. The information providing system according to claim 2, wherein the user terminal further comprises:
a position detector for detecting the position of the user terminal; and
a transmitter for transmitting a request having the modified position as a source position to the information providing server,
wherein the information providing server transmits the position-related information to the user terminal in response to the request from the user terminal.

4. The information providing system according to claim 1, further comprising:
an intervening device connected to the network, for intervening in communication from the user terminal to the information providing server,
wherein the intervening device comprises the position modifier.

5. The information providing system according to claim 1, further comprising:
an intervening device connected to the network, for intervening in communication from the user terminal to the information providing server,
wherein
the user terminal comprises:
the position detector; and
a first transmitter for transmitting a first request having the position to the intervening device through the network, and
the intervening device comprises:
a receiver for receiving the first request from the user terminal;
the position modifier for modifying the position of the user terminal included in the first request to produce the modified position; and
a second transmitter for transmitting a second request having the modified position as a source position to the information providing server,
wherein the information providing server transmits the position-related information to the user terminal in response to the second request received from the intervening device.

6. The information providing system according to claim 1, wherein the modified position is set to an arbitrary position within a predetermined radius of the position of the user terminal.

7. The information providing system according to claim 1, wherein the modified position is set to an arbitrary position at a predetermined distance away from the position of the user terminal.

8. The information providing system according to claim 1, wherein the position of the user terminal is represented by at least two values, wherein the modified position is represented by reducing the number of significant figures of each of said at least two values.

9. The information providing system according to claim 5, wherein the modified position is set to an arbitrary position within a radius of the position of the user terminal, wherein the radius is set to a distance from the position of the user terminal to that of a selected other user terminal.

10. The information providing system according to claim 9, wherein the intervening device further comprises:
a table for storing position information of the plurality of user terminals,
wherein the position modifier modifies the position of the user terminal by searching the table to select one of positions of the plurality of user terminals.

11. An information providing method for providing position-related information from an information providing server to a user terminal through a network to which a plurality of user terminals are connected, wherein the position-related information relates to a position of the user terminal, the method comprising the steps of:
a) detecting the position of the user terminal;
b) modifying the position of the user terminal to produce a modified position; and
c) transmitting the modified position as a position of the user terminal to the information providing server.

12. The information providing method according to claim 11, wherein at least the step b) is performed by the user terminal.

13. The information providing method according to claim 12, wherein the step a) and c) are further performed by the user terminal, the step c) comprising the steps of:
producing a request having the modified position as a source position; and
transmitting the request to the information providing server,
wherein the user terminal receives the position-related information as a response to the request from the information providing server.

14. The information providing method according to claim 11, further comprising:
at an intervening device connected to the network,
intervening in communication from the user terminal to the information providing server,
wherein the step b) is performed by the intervening device.

15. The information providing method according to claim 11, further comprising;
at the user terminal,
transmitting a first request having the position to the intervening device through the network;
at an intervening device connected to the network,
receiving the first request from the user terminal,
modifying the position of the user terminal included in the first request to produce the modified position; and
transmitting a second request having the modified position as a source position to the information providing server,
wherein the information providing server transmits the position-related information to the user terminal in response to the second request received from the intervening device.

16. The information providing method according to claim 11, wherein the modified position is set to an arbitrary position within a predetermined radius of the position of the user terminal.

17. The information providing method according to claim 11, wherein the modified position is set to an arbitrary position at a predetermined distance away from the position of the user terminal.

18. The information providing method according to claim 11, wherein the position of the user terminal is represented by at least two values, wherein the modified position is represented by reducing the number of significant figures of each of said at least two values.

19. The information providing method according to claim 15, wherein the modified position is set to an arbitrary position within a radius of the position of the user terminal, wherein the radius is set to a distance from the position of the user terminal to that of a selected other user terminal.

20. The information providing method according to claim 19, further comprising the steps of:
at the intervening device,
storing position information of the plurality of user terminals in a table; and
searching the table to select one of positions of the plurality of user terminals to modify the position of the user terminal.

21. A user terminal in an information providing system for providing position-related information from an information providing server to the user terminal through a network to which a plurality of user terminals are connected, wherein the position-related information relates to a position of the user terminal, comprising:
a position modifier for modifying a position of the user terminal to produce a modified position,
wherein the modified position is transmitted as a position of the user terminal to the information providing server.

22. The user terminal according to claim 21, further comprising:
a position detector for detecting the position of the user terminal; and
a transmitter for transmitting a request having the modified position as a source position to the information providing server.

23. A program instructing a computer to transmit a request for position-related information to an information providing server through a network to which a plurality of user terminals are connected, wherein the position-related information relates to a position of a user terminal, the program comprising the steps of:
a) inputting the position of the user terminal;
b) modifying the position of the user terminal to produce a modified position; and
c) transmitting the modified position as a position of the user terminal to the information providing server.

24. A privacy protection method in a communications system composed of a server and a plurality of user terminals, which are connected via a network, comprising the steps of:
detecting the position of a user terminal;
modifying the position of the user terminal to produce a modified position; and
transmitting the modified posit ion as a position of the user terminal to the server.

25. A privacy protection system in a communications system composed of a server and a plurality of user terminals, which are connected via a network, wherein
each of the user terminals comprises:
a position detector for detecting the position of the user terminal;
a position modifier for modifying the position of the user terminal to produce a modified position; and
a transmitter for transmitting the modified position as a position of the user terminal to the server.

26. A privacy protection system comprising:
a plurality of user terminals;
an intervening device;
a server; and
a network connecting the plurality of user terminals, the intervening device and the server,
wherein
each of the user terminals comprises:
a position detector for detecting the position of the user terminal; and
a first transmitter for transmitting the position to the intervening device via the network,
the intervening device comprises:
a position modifier for modifying the position of the user terminal to produce a modified position; and
a second transmitter for transmitting the modified position to the server via the network.
